(19) United States
(12) Patent Application Publication
(10) Pub. No.: US 2009/0223352 A1
(43) Pub. Date: Sep. 10, 2009

(54) COMPUTER PROGRAM, INFORMATION REPRODUCING DEVICE, AND METHOD

(75) Inventors: Hiroshi Matsuda, Saitama (JP); Kazuo Kamei, Saitama (JP); Keizo Sugita, Saitama (JP)

Correspondence Address: Young & Thompson, 745 S. 23rd Street., Second Floor, Arlington, VA, 22202, US

(73) Assignee: PIONEER CORPORATION, Tokyo (JP)

(21) Appl. No.: 11/994,427

(22) PCT Filed: Jun. 30, 2006
(86) PCT No.: PCT/JP2006/313069

§ 371 Date: May 2, 2008

(30) Foreign Application Priority Data
Jul. 1, 2005 (JP) 2005-194026

(51) Int. Cl. G10H 1/40

(52) U.S. Cl. 84/612

(57) ABSTRACT

A computer program makes a computer perform: a measuring process of measuring a beat rate, which is the number of beats of content per unit time; a first detecting process of detecting a beat position; a generating process of generating a beat guide which is to be displayed in accordance with the beat position and which has a substantially uniform interval in accordance with the beat rate along a time axis, on the basis of the beat rate and the beat position; a second detecting process of detecting a positional shift between the beat guide and the beat position; an offset process of adding an offset to a position of the beat guide on the basis of the positional shift; and a displaying process of displaying the beat guide to which the offset is added.

### TECHNICAL FIELD

The present invention relates to a computer program which makes a computer function to reproduce a music song or the like recorded on a recording medium, and an information reproducing apparatus and method for reproducing the music song or the like recorded on the recording medium.

### BACKGROUND ART

Currently, there are spread recording media, such as a CD and a DVD, on which data can be recorded and reproduced by using a digital signal. Along with that, an information reproducing apparatus for performing a unique reproduction process by using the digital signal has been also developed. For example, in the CD and the DVD, a plurality of music songs (i.e. content data) are recorded in association with each other. More specifically, for example, music songs each of which has a predetermined reproduction time are recorded as a plurality of data groups distinguished by a track number. Thus, the information reproducing apparatus can perform cue-playback in which the head address of each music song is searched for and then the music song is reproduced, random-playback in which the reproduction order of each music song is arbitrarily changed, and the like.

Moreover by using two or more information reproducing apparatuses and continuously reproducing the music songs while matching the beat position, interval, accentuation or the like of the music songs to be reproduced on the respective information reproducing apparatuses, it is possible to reproduce two or more music songs as if they are one continuous music song, or it is possible to overlap the two or more music songs. That is, it is possible to reproduce a plurality of music songs in a row or together, without bothering an audience. Such an operation is generally referred to as a mixing operation. At this time, the beat of each music song is displayed on a display screen as a beat rate or the number of beats per unit time, which is typically expressed by e.g. an automatically measured BPM (Beat Per Minute) value. A user confirms the displayed beat rate and performs the aforementioned mixing operation.

Moreover, as a display for complementing the user's operation in the mixing operation, there is also developed a technology of further displaying guides at uniform intervals corresponding to the beat rate value, while making the guides overlap the waveform of a reproduction signal of the music song and making the guides correspond to the beat positions in the music song in addition to the display of the beat rate. Alternatively, there is also developed a technology of further displaying guides at uniform intervals corresponding to the beat rate value by using a blinking indicator or the like.

Incidentally, a patent document 1 is associated with the present invention in terms of displaying the guides. Specifically, the patent document 1 discloses a technology of quantizing MIDI data, which is a technology of adjusting phonetic data, which is off timing, to the correct timing.

Patent document 1 Japanese Patent No. 3221293

### DISCLOSURE OF INVENTION

### Subject to be Solved by the Invention

In the guide corresponding to the beat rate, however, the guide position and the beat position may be sometimes shifted from each other depending on the characteristic of the music song, because the interval between the guides is fixed on the basis of the beat rate. Specifically, for example, the music song does not have the uniform beat rate in the entire reproduction time and the beat rate changes every moment along with the reproduction. Moreover, even if the beat rate in a certain reproduction section is constant, the rhythm or the like of the music song changes every moment. The change in the beat rate and rhythm or the like along with the reproduction causes the shift between the guide position and the beat position. Thus there is such a technical problem that the guide that is originally to indicate the beat position does not function properly. This is not desirable in that the user is confused wastefully.

The subject to be solved by the present invention includes the above-exemplified problem as one example. It is therefore an object of the present invention to provide a computer program, an information reproducing apparatus and method which can present a more correct guide to a user.

### Means for Solving the Subject

Computer Program

The above object of the present invention can be achieved by a computer program for making a computer perform: a measuring process of measuring a beat rate, which is the number of beats of content per unit time; a first detecting process of detecting a beat position; a generating process of generating a beat guide which is to be displayed in accordance with the beat position and which has a substantially uniform interval in accordance with the beat rate along a time axis, on the basis of the beat rate and the beat position; a second detecting process of detecting a positional shift between the beat guide and the beat position; an offset process of adding an offset to a position of the beat guide on the basis of the positional shift; and a displaying process of displaying the beat guide to which the offset is added.

According to the computer program of the present invention, an information reproducing apparatus (specifically, the information reproducing apparatus of the present invention described later) can be relatively easily realized as a computer reads and executes the computer program from a program storage device, such as a ROM, a CD-ROM, a DVD-ROM, and a hard disk, or as it executes the computer program after downloading the program through a communication device.

Specifically, the computer program of the present invention makes the computer perform: the measuring process; the first detecting process; the generating process; the second detecting process; the offset process; and the displaying process. By performing the measuring process on the computer, the beat rate, which indicates the number of beats per unit time, is measured in the content which is a reproduction target by the information reproducing apparatus realized on the computer by executing the computer program. Moreover, by performing the first detecting process on the computer, the beat position (specifically, a signal portion in which a signal level is relatively high or outstanding from among a reproduction signal of the content) is detected. After that, by performing the generating process on the computer, the beat guide, which is to be displayed in accordance with the beat position and which has a substantially uniform interval in accordance with the beat rate measured in the measuring process, is generated along the reproduction time axis. The beat guide generated here is preferably displayed on a display screen actually after the offset process described later is performed; however, the beat guide may be displayed on the display screen actually at the same time when the generating process is performed (i.e. before the offset described later is added). At this time, the beat guide generated in the generating process is not generated strictly corresponding to the actual beat position, and it is generated mainly on the basis of the interval according to the beat rate on the time axis. Therefore, the beat guide does not necessarily correspond to the actual beat position. Thus, the computer program of the present invention further makes the computer perform the second detecting process and the offset process. By performing the second detecting process on the computer, the positional shift between the beat guide and the beat position is detected. After that, by performing the offset process on the computer, the offset is added to the beat guide such that the beat guide corresponds to the beat position (in other words, such that the positional shift is eliminated or reduced) on the basis of the positional shift detected in the second detecting process. After that, by performing the displaying process on the computer, the beat guide to which the offset is added (i.e. which more preferably corresponds to the beat position) is presented to a user.

As described above, with respect to the beat guide heretofore disposed with a constant interval according to the beat rate, the position of the beat guide can be corrected on the basis of the positional shift between the beat guide and the beat position. Thus, it is possible to present the beat guide preferably corresponding to the beat position, to the user. Therefore, the user can preferably match the cue of the content-point and a reproduction-start-point to the beat position, with reference to the beat guide preferably corresponding to the beat position. As a result, it is possible to reproduce the content in a more preferable aspect.

In one aspect of the computer program of the present invention, the second detecting process detects the positional shift between the beat guide and the beat position in an at least partial reproduction section of the content, and the offset process adds the offset to the position of the beat guide in the at least partial reproduction section, on the basis of the positional shift in the at least partial reproduction section.

According to this aspect, the entire content is divided into the plurality of reproduction sections, and the positional shift is measured in each of the divided reproduction sections. Moreover, the preferable offset can be added to the beat guide on the basis of the positional shift.

Incidentally, as the divided reproduction section becomes smaller, the positional shift of the beat guide from the beat position is further eliminated. On the other hand, as the divided reproduction section becomes larger, a processing load required for the addition of the offset to the beat guide can be further reduced.

In this aspect, the offset process may add the offset to the position of the beat guide in a reproduction section other than the at least partial reproduction section, on the basis of the positional shift in the at least partial reproduction section.

By virtue of such construction, with respect to the content in which the reproduction signal having the same tendency repeatedly appears, if the positional shift in one reproduction section which is divided in view of a repeating pattern (repeating tendency) is detected, it is possible to add the offset to the beat guide in the reproduction section of the entire content on the basis of the positional shift. Therefore, it is possible to reduce a processing load required for the detection of the positional shift and the setting of the offset based on the positional shift.

In this aspect, the at least partial reproduction section may be at least one reproduction section in the case where the content is divided into a plurality of reproduction sections along a time axis on the basis of the beat rate. Alternatively, the at least partial reproduction section may be at least one reproduction section in the case where the content is divided into a plurality of reproduction sections along a time axis on the basis of a reproduction time of the content.

By virtue of such construction, it is possible to preferably divide the entire content into the plurality of reproduction sections, relatively easily. It is also possible to measure the positional shift in each of the divided reproduction sections and add the preferable offset to the beat guide on the basis of the positional shift.

In another aspect of the computer program of the present invention, the second detecting process detects the positional shift between the beat guide and a rising portion of the beat position, and the offset process adds the offset to the position of the beat guide such that the beat guide corresponds to the rising portion of the beat position on the basis of the positional shift.

According to this aspect, the beat guide can be set to the head portion of the beat (i.e. a portion where the signal level starts to increase).

In another aspect of the computer program of the present invention, the second detecting process detects the positional shift between the beat guide and a peak portion of the beat position, and the offset process adds the offset to the position of the beat guide such that the beat guide corresponds to the peak portion of the beat position on the basis of the positional shift.

According to this aspect, the beat guide can be set to the portion of the beat where the signal level becomes the highest (i.e. the peak portion).

In another aspect of the computer program of the present invention, the second detecting process detects an average value of positional shifts between a plurality of beat guides and a plurality of beat positions corresponding to the respective plurality of beat guides, as the positional shift.

According to this aspect, the average of the positional shifts in the entire content or in each of the reproduction sections which are obtained by dividing the entire content is detected. Then, the offset set on the basis of the average of the positional shifts can be added to the beat guide in the entire content, in the entire content when the entire content is divided into the plurality of reproduction sections, or in each of the reproduction sections. Therefore, it is possible to present the beat guide preferably corresponding to the beat position, to the user.

In another aspect of the computer program of the present invention, the second detecting process detects a tendency in a change of the positional shift between the beat guide and the beat position, as the positional shift.

According to this aspect, the tendency in the change of the positional shift in the entire content or in each of the reproduction sections which is obtained by dividing the entire content is detected. Then, the offset set on the basis of the tendency in the change of the positional shift can be added to the beat guide in the entire content or in each of the reproduction sections. For example, if the positional shift changes to gradually increase in the entire content or in a certain reproduction section, the offset added to the beat guide in the entire content or in the certain reproduction section may be also set to gradually increase. For example, if the positional shift changes to gradually decrease in the entire content or in a certain reproduction section, the offset added to the beat guide in the entire content or in the certain reproduction section may be also set to gradually decrease. Therefore, it is possible to present the beat guide preferably corresponding to the beat position, to the user.

In another aspect of the computer program of the present invention, the offset is fixed.

According to this aspect, the offset set as a fixed value on the basis of the detected positional shift can be preferably added to the beat guide.

In another aspect of the computer program of the present invention, the offset is variable.

According to this aspect, the offset set as a value which dynamically changes on the basis of the detected positional shift can be preferably added to the beat guide.

In another aspect of the computer program of the present invention, the displaying process displays the beat guide with a waveform of a reproduction signal of the content.

According to this aspect, the beat guide can be displayed in accordance with an aspect of changes of the reproduction signal of the content (e.g. a change, such as increase and decrease, and up and down, in the signal level). Therefore, the user can recognize the beat guide in visual association with the reproduction of the content, so that it is possible to reproduce the content in a more preferable aspect.

In another aspect of the computer program of the present invention, the content includes music content.

According to this aspect, it is possible to perform the aforementioned operations on the content including the music content.

In another aspect of the computer program of the present invention, the displaying process displays the beat guide generated in the generating process before displaying the beat guide to which the offset is added.

According to this aspect, in addition to the beat guide to which the offset is added (i.e. which is corrected), the beat guide before the offset is added (i.e. which is not corrected) can be also presented to the user.

The above object of the present invention can be also achieved by a computer program product in a computer-readable medium for making a computer perform: a measuring process of measuring a beat rate, which is the number of beats of content per unit time; a first detecting process of detecting a beat position; a generating process of generating a beat guide which is to be displayed in accordance with the beat position and which has a substantially uniform interval in accordance with the beat rate along a time axis, on the basis of the beat rate and the beat position; a second detecting process of detecting a positional shift between the beat guide and the beat position; an offset process of adding an offset to a position of the beat guide on the basis of the positional shift; and a displaying process of displaying the beat guide to which the offset is added.

According to the computer program product of the present invention, an information reproducing apparatus (specifically, the information reproducing apparatus of the present invention described later) can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as an information reproducing apparatus (specifically, the information reproducing apparatus of the present invention described later).

(Information Reproducing Apparatus)

The above object of the present invention can be also achieved by an information reproducing apparatus provided with: a measuring device for measuring a beat rate, which is the number of beats of content per unit time; a first detecting device for detecting a beat position; a generating device for generating a beat guide which is to be displayed in accordance with the beat position and which has a substantially uniform interval in accordance with the beat rate along a time axis, on the basis of the beat rate and the beat position; a second detecting device for detecting a positional shift between the beat guide and the beat position; an offset device for adding an offset to a position of the beat guide on the basis of the positional shift; and a displaying device for displaying the beat guide to which the offset is added.

According to the information reproducing apparatus of the present invention, it is possible to receive the same various benefits as those of the computer program of the present invention described above.

Incidentally, in response to the various aspects of the aforementioned computer program of the present invention, the information reproducing apparatus of the present invention can employ various aspects.

(Information Reproducing Method)

The above object of the present invention can be also achieved by an information reproducing method provided with: a measuring process of measuring a beat rate, which is the number of beats of content per unit time; a first detecting process of detecting a beat position; a generating process of generating a beat guide which is to be displayed in accordance with the beat position and which has a substantially uniform interval in accordance with the beat rate along a time axis, on the basis of the beat rate and the beat position; a second detecting process of detecting a positional shift between the beat guide and the beat position; an offset process of adding an offset to a position of the beat guide on the basis of the positional shift; and a displaying process of displaying the beat guide to which the offset is added.

According to the information reproducing method of the present invention, it is possible to receive the same various benefits as those of the information reproducing apparatus of the present invention described above.

Incidentally, in response to the various aspects of the aforementioned information reproducing apparatus of the present invention, the information reproducing method of the present invention can employ various aspects.

These effects and other advantages of the present invention will become more apparent from the following embodiments.

As explained above, according to the computer program of the present invention, it makes a computer perform: the measuring process; the first detecting process; the generating process; the second detecting process; the offset process; and the displaying process. Moreover, according to the information reproducing apparatus of the present invention, it is provided with: the measuring device; the first detecting device; the generating device; the second detecting device; the offset device; and the displaying device. Moreover, according to the information reproducing method of the present invention, it is provided with: the measuring process; the first detecting process; the generating process; the second detecting process; the offset process; and the displaying process. Therefore, it is possible to present the beat guide preferably corresponding to the beat position, to the user.

### BRIEF DESCRIPTION OF DRAWINGS

FIG. 1 is a block diagram generally showing the basic structure of an optical disc reproduction system in an embodiment.

FIG. 2 is a plan view conceptually showing the specific display content of a reproduction state display portion of the optical disc reproduction system shown in FIG. 1.

FIG. 3 is a block diagram generally showing the basic structure of an optical disc reproduction system in an embodiment.

FIG. 4 is a block diagram conceptually showing functional blocks realized in a computer provided for the optical disc reproduction system in the embodiment.

FIG. 5 is a flowchart conceptually showing a flow of the operations of the optical disc reproduction system in the embodiment.

FIG. 6 is a graph conceptually showing a reproduction waveform of content data.

FIG. 7 is a waveform chart conceptually showing one procedure of detection of a beat position and a beat head.

FIG. 8 is a waveform chart conceptually showing another procedure of the detection of the beat position and the beat head.

FIG. 9 is a waveform chart conceptually showing another procedure of the detection of the beat position and the beat head.

FIG. 10 is a graph conceptually showing a waveform of a detection signal by a TAP operation.

FIG. 11 is a waveform chart generally showing a relationship between the beat position and the position of beat guide before an offset amount is added.

FIG. 12 is a waveform chart generally showing a relationship between the beat position and the position of the beat guide after the offset amount is added.

FIG. 13 are graphs conceptually showing a shift amount in each section and aspects of setting the offset amount based on the shift amount.

FIG. 14 is a block diagram conceptually showing the basic structure of an optical disc reproducing apparatus in an embodiment.

### DESCRIPTION OF REFERENCE CODES

1 optical disc reproduction system
10 display window
12 reproduction state display portion
17 jog dial
100 display
120 beat guide
200 computer
211 BPM measurement block
212 signal level detection block
213 guide timing generation block
214 timing comparison/analysis block
215 display block
500 optical disc reproducing apparatus

### BEST MODE FOR CARRYING OUT THE INVENTION

Hereinafter, the best mode for carrying out the invention will be explained in each embodiment in order, with reference to the drawings.

Incidentally, in the following embodiments, the computer program of the present invention is applied to a computer program for realizing, on a computer, an optical disc reproducing apparatus, such as a CD player and a DVD player, with various reproduction functions represented by reproduction speed control, tempo control, and rewind reproduction and the like. Therefore, in the following embodiments, an explanation will be given on the structure and operation of a computer in which such a computer program is read (more specifically, an optical disc reproduction system provided with such a computer).

Incidentally, the computer in which such a computer program is read (more specifically, the optical disc reproduction system provided with such a computer) functions as an optical disc reproducing apparatus, and such an optical disc reproducing apparatus corresponds to one specific example of the information reproducing apparatus of the present invention. Moreover, the optical disc reproduction system in the embodiment explained below is used as DJ equipment (including VJ (Video Jockey) equipment) used in adding various special effects to music data or video data and continuously reproducing the data while changing optical discs one after another at a dance place, such as a disco.

(1) Basic Structure

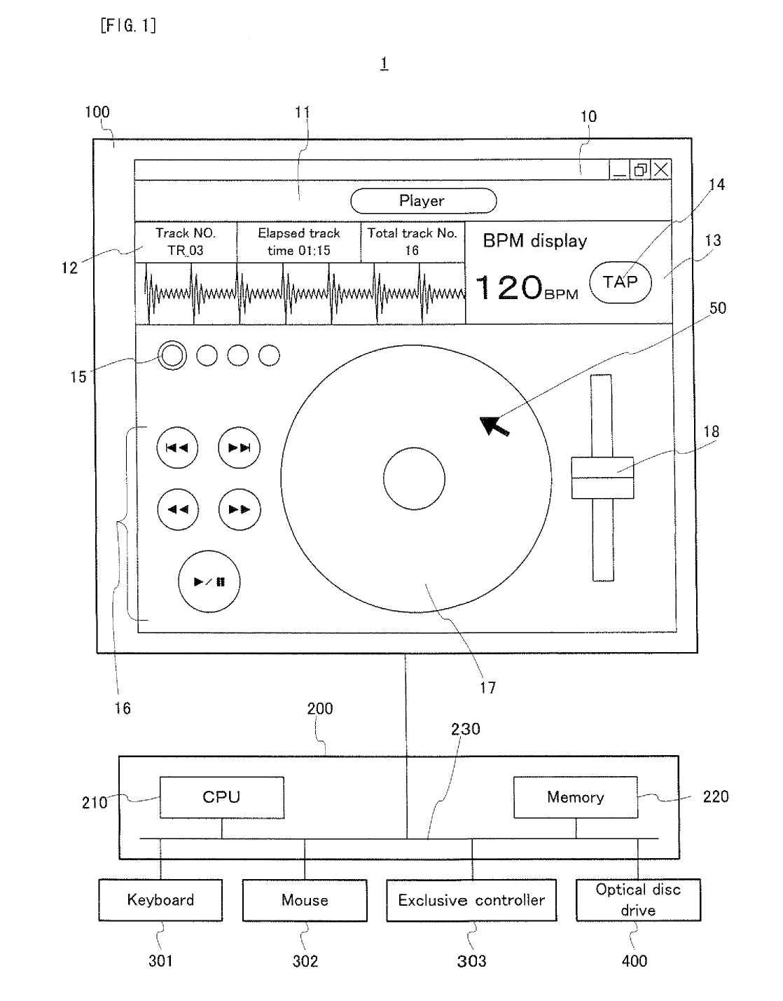

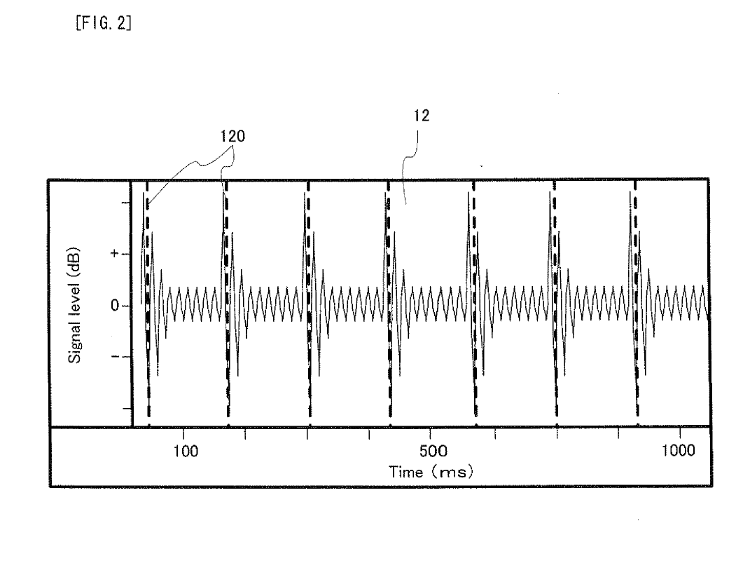

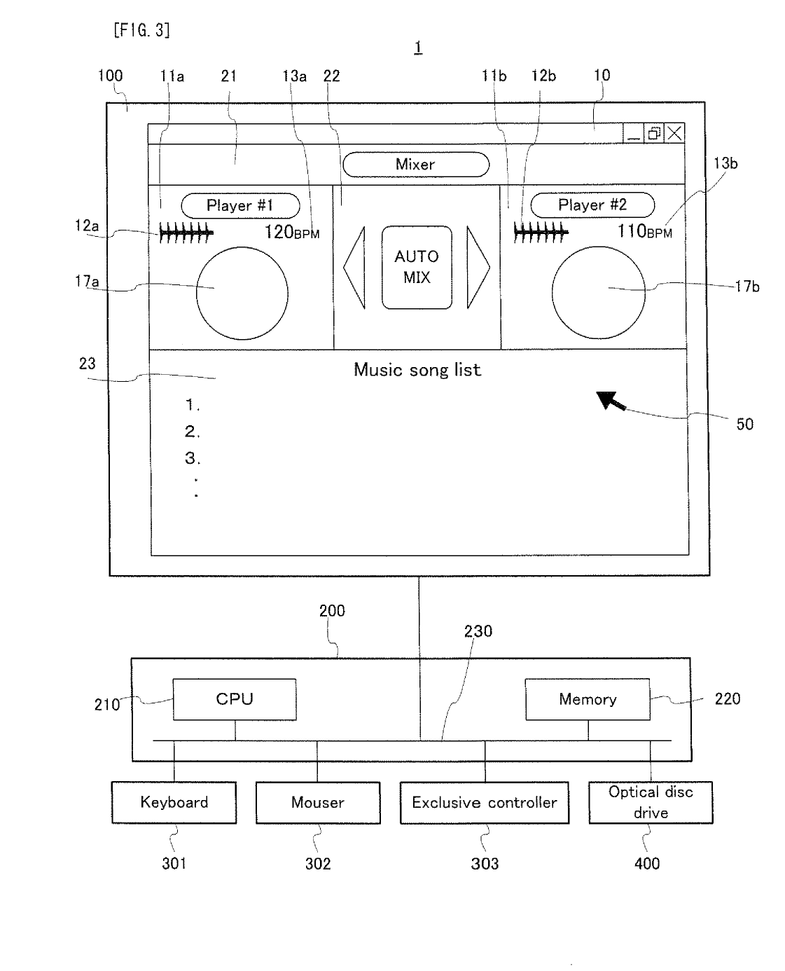

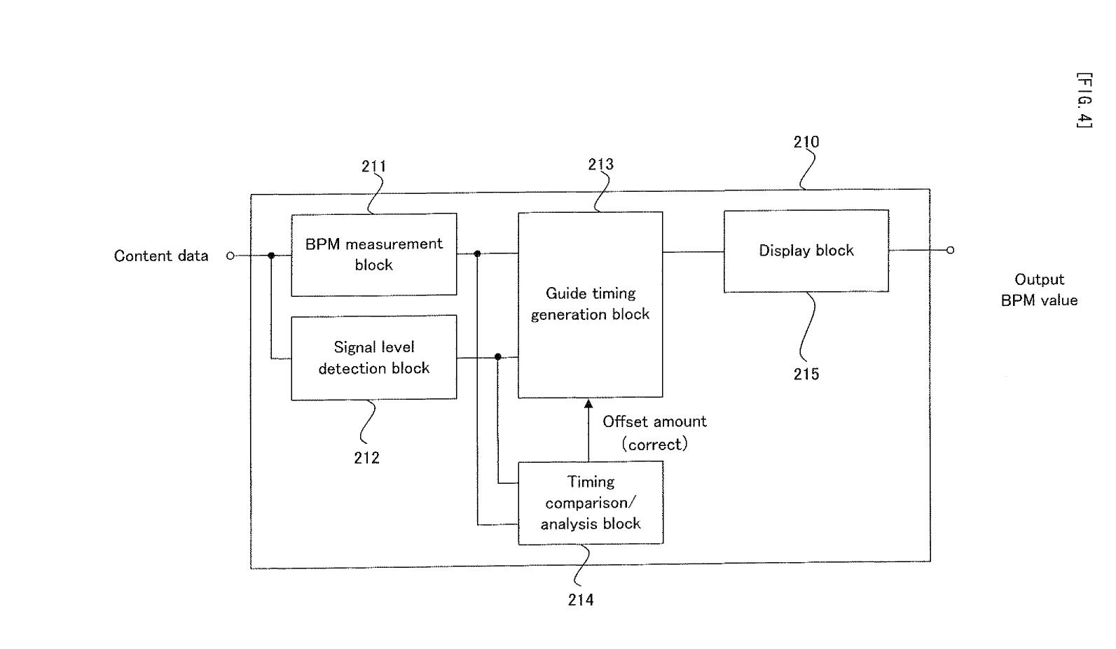

Firstly, with reference to FIG. 1 to FIG. 4, the basic structure of the optical disc reproduction system in the embodiment will be explained. FIG. 1 is a block diagram generally showing one basic structure of the optical disc reproduction system in the embodiment. FIG. 2 is a plan view conceptually showing the specific display content of a reproduction state display portion of the optical disc reproduction system shown in FIG. 1. FIG. 3 is a block diagram generally showing another basic structure of the optical disc reproduction system in the embodiment. FIG. 4 is a block diagram conceptually showing functional blocks realized in a computer provided for the optical disc reproduction system in the embodiment.

As shown in FIG. 1, an optical disc reproduction system 1 in the embodiment is provided with: a display 100; a computer 200; a keyboard 301; a mouse 302; an exclusive controller 303; and an optical disc drive 400.

The display 100 includes, for example, a LCD (Liquid Crystal Display), a cathode-ray tube display, or the like, and it is adapted to display a predetermined display window 10 in accordance with an instruction from the computer 200.

In FIG. 1, in particular, the display window 10 displays a player menu 11 which has an appearance of a player or the like used as the DJ equipment. The player menu 11 displays a reproduction state display portion 12, a BPM display portion, a TAP button 14, an indicator 15, an operation key 16, a jog dial 17, a slider IS, and a mouse pointer 50.

The reproduction state display portion 12 displays various information according to the reproduction of content data including a music song. For example, the reproduction state display portion 12 displays, on the top, a truck number of currently reproduced content data, an elapsed time of the currently reproduced content data (i.e. a current reproduction time), the total track number of the content data recorded on an optical disc currently loaded on the optical disc drive 400, and the like. In an example of the display shown in FIG. 1, it is possible to recognize that the content data with a track number of 3 is currently reproduced, that 1 minute 15 seconds has elapsed since the reproduction start, and that the total track number of the content data recorded on the optical disc loaded on the optical disc drive 400 is “16.

Moreover, the reproduction state display portion 12 displays, on the bottom, as shown in more detail in FIG. 2, a signal waveform of a reproduction signal of the content data along a reproduction time axis and a beat guide 120 which indicates the beat position of the content data (in other words, the peak position of the reproduction signal). The plurality of beat guides 120 are displayed substantially in the respective beat positions of the content data.

Of course, the display content on the reproduction state display portion 12 shown in FIG. 1 and FIG. 2 is one specific example. It is obvious that other various information or the like may be displayed.

In FIG. 1 again, the BPM display portion 13 displays a BPM value which indicates the number of beats per unit time (in other words, a beat rate) of the currently reproduced content data. The BPM value displayed on the BPM display portion 13 may be a BPM value automatically measured by the operation of the computer 200, or a BPM value inputted to the optical disc reproduction system 1 by a user (i.e. a user of the optical disc reproduction system, specifically a DJ or the like) which presses the TAP button 14.

The TAP button 14 is constructed as a display button which can be pressed by a click operation or the like with the pointer 50 which arbitrarily moves in a screen of the display 100 by operating the keyboard 301 and the mouse 302 or the like. By pressing the TAP button 14, the user can input the PPM value to the optical disc reproduction system 1. Moreover, by pressing the TAP button 14, the user can input the beat positions or the like to the optical disc reproduction system 1, as described later.

The indicator 15 is constructed as an icon or the like which indicates the operational state of the optical disc reproduction system 1 and the reproduction state of the content data or the like, by blinking light or the like. Moreover, the indicator 15 may repeat the blinking in the same timing as that of the beat guide 120 displayed on the aforementioned reproduction state display portion 12 in accordance with the reproduction of the content data, to thereby present the beat guide 120 indicated by the blinking timing of the indicator 15 and the beat position of the content data (in other words, the peak positions of the reproduction signal) instead of the beat guide 120 displayed on the reproduction state display portion 12.

The operation key 16 is constructed as a display button which can be pressed by the click operation or the like with the pointer 50. By pressing the operation key 16, the operation of the optical disc reproduction system 1 can be changed. That is, it is possible to control the reproduction of the content data, fast-forward, rewind, pause, stop, or the like by the user performing the click operation with the pointer 50 placed on the desired operation key 16.

The jog dial 17 is constructed as a disc-shaped display button which can rotate in both directions by a drag operation or the like with the pointer 50 or the like. If the user or the like changes and operates the rotational direction and the rotational speed of the jog dial 17 with the pointer 50 as occasion demands, it is possible to set the forward reproduction and reverse reproduction of the content data in accordance with the rotational direction. Moreover, in accordance with the rotational speed, the tone of a reproduction sound reproduced on a speaker and a head phone can be changed.

Incidentally, the aforementioned forward reproduction indicates that the content data of the optical disc is reproduced in the recording order as in the case an analog record, such as a LP, is rotated in a forward direction to play music or the like. Therefore, music or the like is reproduced as a normal sound in accordance with the rotation of the jog dial 17 in a clockwise direction. Moreover, the forward reproduction is also performed even when the jog dial 17 is stopped.

On the other hand, the aforementioned reverse reproduction indicates that the content data of the optical disc is reproduced in an opposite order to the recording order as in the case that the analog record is rotated in an opposite direction to play music or the like. That is, since music or the like is continuously recorded (i.e. analog-recorded) in the analog record, if the analog record is rotated in the opposite direction, the music or the like is reproduced in the opposite direction, so that a sound different from the original music or the like is reproduced. If the jog dial 17 is rotated in a counter clockwise direction, the same sound as if the analog record were rotated and played in the opposite direction can be generated by reproducing the individual content data digital-recorded on the optical disc in the opposite order.

Since the same function as that in the reverse reproduction of the analog record is provided, it is possible to generate an imitation sound referred to as a so-called scratch sound (an imitation sound such as squeak and crash) if the user or the like repeats the reciprocating rotation of the jog dial 17 quickly in the clockwise direction and in the counter-clockwise direction. Then, when a player referred to as a so-called disc jockey operates the jog dial 17 to generate the aforementioned scratch sound or the like, it is possible to perform editing to generate rap music or the like by using a CD and a DVD.

The slider 18 is constructed as a display button which can be slid vertically by the drag operation or the like with the pointer 50. By the user or the like vertically displacing the slider 18 with the pointer 50, it is possible to change the reproduction speed of the content data, as occasion demands. For example, the reproduction speed of the content data can be relatively increased by displacing the slider 18 upward, and the reproduction speed of the content data can be relatively reduced by displacing the slider 18 downward.

The computer 200 reproduces the content data recorded in the optical disc loaded on the optical disc drive 400 in various aspects in accordance with instruction from the keyboard 301, the mouse 302, the excusive controller 303 or the like. Moreover, it also performs a drawing process of the display window 10 with respect to the display 100. Specifically, these processes are performed by the operation of a CPU 201, and a program or the like necessary for the operation of the CPU 201 is stored in a memory 220. Moreover, the memory 220 is also used to temporarily store various variables and parameters or the like used when the CPU 201 operates, or to temporarily store the content data. Moreover, the data input/output between the CPU 201 and the memory 202 in the computer 200, and the data input/output between those devices and display 100, the keyboard 301, the mouse 302, the exclusive controller 303, and the optical disc drive 400 are performed through a data bus 230.

The keyboard 301 is provided with various operation keys which can be pressed directly by the user. By the user pressing the operation key of the keyboard 301, the computer 200 can perform various functions assigned to each operation key. For example, if a “P” button as the operation key is pressed the computer 200 may operate to start (or Play) the reproduction of the content data. Alternatively, if an “S” button as the operation key is pressed, the computer 200 may operate to Stop the reproduction of the content data.

The mouse 302 displaces the pointer 50 displayed on the display 100, in a screen of the display 100, in accordance with the direct operation amount or the like of the mouse 302 by the user. Moreover, by the user directly pressing a click button attached to the mouse 302, it is possible to perform the click operation, the drag operation, or the like. Incidentally, it is obvious that the operation of the mouse 302 may be alternately performed by the keyboard 301.

The exclusive controller 303 is provided with substantially the same physical operation key or the like as the display content of the player menu 11 displayed in the display window 10. By the user directly operating the physical operation key provided for the exclusive controller 303, the user can perform a smooth operation as if the user directly operated the play menu 11.

The optical disc drive 400 loads the optical disc on which the content data is recorded, reads the content data, and transfers the read content data to the computer 200.

As shown in FIG. 3, the optical disc reproduction system 1 in the embodiment can also display a mixer menu 21 in the display window 10, instead of or in addition to the player menu 11.

The mixer menu 21 displays a first player menu 11a, a second player menu 11b, a mixer operation portion 22, and a music song list display portion 23.

The mixer operation portion 22 includes a display button or the like which can perform an operation to mix the content data which is a reproduction target in the first player menu 11a with the content data which is a reproduction target in the second player menu 11b. The user performs mixing with reference to a music song list displayed on the music song list display portion 23, the display content of the reproduction state display portion 12a and the BPM display portion 13a in the first player menu 11a, and the display content of the reproduction state display portion 12b and the BPM display portion 13b in the second player menu 11b.

As explained above, the optical disc reproduction system 1 in the embodiment can realize the DJ equipment, such as the mixer, the CD player, and the DVD player, on the computer 200. These are realized by reading the computer program in the embodiment into the computer 200 and executing the computer program. Then, a processing circuit block included in the mixer, the CD player, and the DVD player or the like, which is generally realized as a physical circuit, such as an IC and a LSI, or which is functionally realized on the IC or the LSI or the like, is realized as functional blocks on the CPU 201 provided for the computer 200.

Now, with reference to FIG. 4, the functional blocks realized on the CPU 201 in the optical disc reproduction system 1 in the embodiment, the functional blocks for displaying the beat guide 120 on the reproduction state display portion 12 of the player menu 11 will be explained in detail. FIG. 4 is a block diagram conceptually showing the functional blocks for displaying the beat guide 120 on the reproduction state display portion 12 of the player menu 11.

As shown in FIG. 4, on the CPU 201, a BPM measurement block 211, a signal level detection block 212, a guide timing generation block 213, a timing comparison/analysis block 214, and a display block 215 are realized as the functional blocks for displaying the beat guide 120 on the reproduction state display portion 12 of the player menu 11.

The BPM measurement block 211 is adapted to obtain the content data which is currently a reproduction target and measure its BPM value. The measured BPM value is outputted to each of the guide timing generation block 213 and the timing comparison/analysis block 214. Incidentally, the BPM value measured on the BPM measurement block 211 is displayed on the BPM display portion 13 of the player menu 11.

The signal level detection block 212 is adapted to detect a signal level of a reproduction signal of the content data. Moreover, it is also adapted to detect the peak position of the reproduction signal (in other words, the beat position) from the detected signal level. The detected signal level and beat position are outputted to each of the guide timing generation block 213 and the timing comparison/analysis block 214.

The guide timing generation block 213 is adapted to generate the display timing of the beat guide 120 in association with the reproduction time of the content data, on the basis of the BPM value which is outputted from the BPM measurement block 211 and the beat position and the signal level which are outputted from the signal level detection block 212. The display timing of the beat guide 120 is outputted to the display block 215.

The timing comparison/analysis block 214 is adapted to set an offset amount to be added to the display timing of the beat guide 120, on the basis of the BPM value which is outputted from the BPM measurement block 211 and the beat position and the signal level which are outputted from the signal level detection block 212. The calculated offset amount is outputted to the guide timing generation block 213. The guide timing generation block 213 which receives the offset amount generates the display timing of the beat guide 120 while adding the offset amount. In other words, the guide timing generation block 213 which receives the offset amount generates the display timing of the beat guide 120 while correcting the display timing on the basis of the offset amount.

The display block 215 displays the beat guide 120 on the display 100 in accordance with the reproduction signal of the content data, as shown in FIG. 2, on the basis of the display timing of the beat guide 120 generated by the guide timing generation block 213.

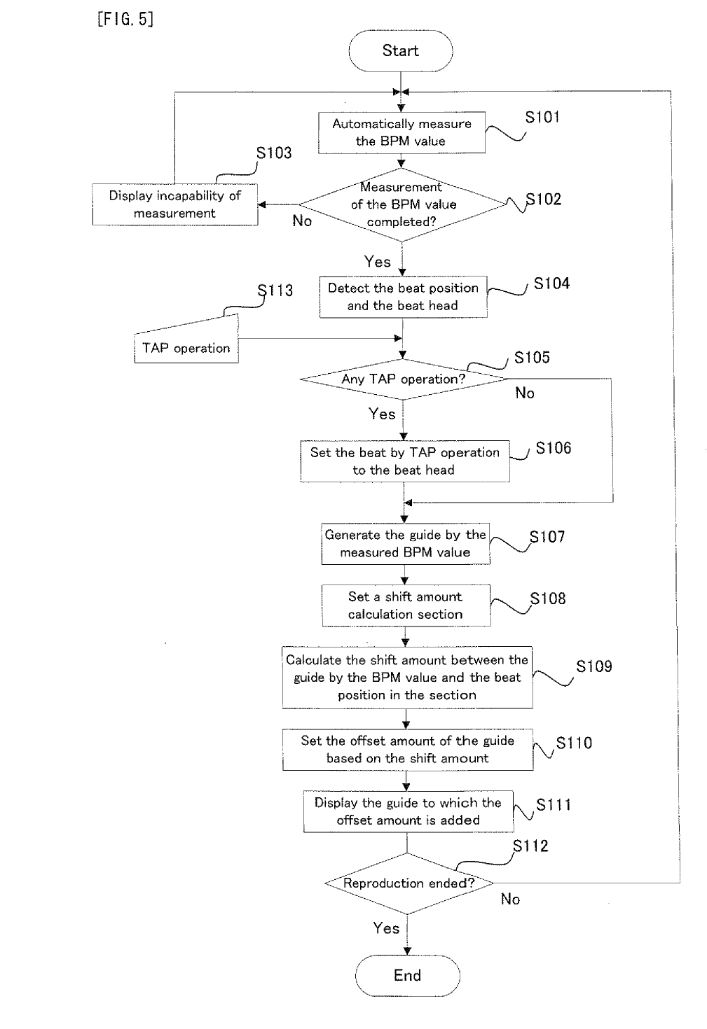

Incidentally, the operation of each block shown in FIG. 4 (specifically, a method of measuring the BPM value on the BPM measurement block 211, a method of detecting the beat position and the signal level on the signal level detection block 212, a method of generating the display timing of the beat guide 120 on the guide timing generation block 213, a method of comparison or the like on the timing comparison/analysis block 214, or the like) will be described in detail later (refer to FIG. 5 or the like).

(2) Operation Principle

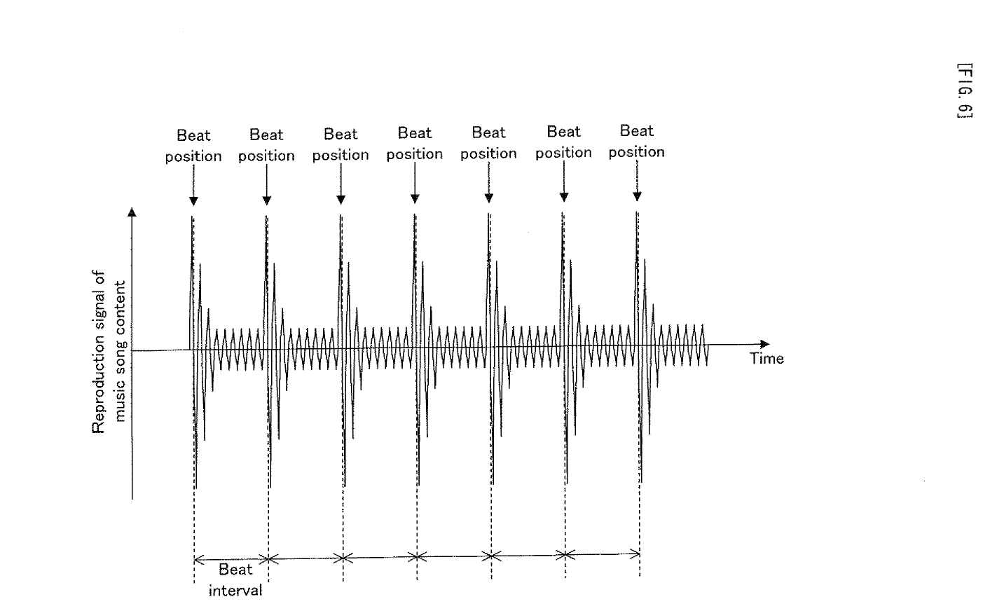

Next, with reference to FIG. 5 to FIG. 13, the operation principle of the optical disc reproduction system 1 in the embodiment will be explained. Here, an entire flow of the operation principle of the optical disc reproduction system 1 in the embodiment will be explained with reference to FIG. 5, and a more detailed explanation will be given with reference to FIG. 6 to FIG. 13, as occasion demands. FIG. 5 is a flowchart conceptually showing a flow of the operations of the optical disc reproduction system in the embodiment.

Incidentally, FIG. 5 explains the operation performed in parallel with the reproduction of the content data. More specifically, FIG. 5 explains the operation when the beat guide 120 is displayed on the reproduction state display portion 12 of the player menu 11. Therefore, although FIG. 5 does not clearly show that the content data is reproduced, it is assumed that the content data is obviously reproduced when the operation shown in FIG. 5 is performed.

As shown in FIG. 5, firstly, by the operation of the BPM measurement block 211, the BPM value of the currently reproduced content data is measured (step S101). In other words, without the user's operation, the BPM value of the currently reproduced content data is so-called automatically measured.

Now with reference to FIG. 6, the method of measuring the BPM value in the step S101 in FIG. 5 will be explained in more detail. FIG. 6 is a graph conceptually showing a reproduction waveform of content data.

As shown in FIG. 6, if the content data is reproduced, a reproduction signal which is relatively strong (i.e. with large amplitude) is obtained at a position where the beat appears (i.e. the beat position). The inverse number of the average of the interval of the beats (i.e. beat interval) in each certain section is the BPM value. For example, if the average of the beat interval is 400 (msec), the BPM value is obtained by the following equation.

$$\begin{matrix}B P M value = \frac{1}{400 \times {10}^{- 3}} \times 60 \\ = 150 B P M\end{matrix} \qquad [ Equation 1 ]$$

Incidentally, the reproduction signal of the content data may be divided in each frequency band, the BPM value of a signal component in each frequency band may be measured, and the BPM value of the signal component in the frequency band in which the clearest and most stable beat interval can be recognized from among the signal components in the respective frequency bands may be displayed on the BPM display portion 12. Specifically, firstly, a BPM candidate value of the signal component in each of lower (low frequency band), middle (middle frequency band), and higher (higher frequency band) ranges is measured. For example, it is measured such that the BPM candidate value of the signal component in the lower range is “a”, that the BPM candidate value of the signal component in the middle range is “b”, and that the BPM candidate value of the signal component in the higher range is “c”. Among them, if the clearest and most stable beat interval can be recognized in the signal component in the lower range, “a” is displayed as the BPM value on the BPM display portion 12. Among them, if the clearest and most stable beat interval can be recognized in the signal component in the middle range, “b” is displayed as the BPM value on the BPM display portion 12. Among them, if the clearest and most stable beat interval can be recognized in the signal component in the higher range, “c” is displayed as the BPM value on the BPM display portion 12.

In FIG. 4 again, then it is judged whether or not the BPM value is measured in the step S101 (step S102). That is, it is judged whether or not the beat position shown in FIG. 5 can be preferably recognized and the BPM value can be recognized on the basis of the recognized beat position.

As the result of the judgment, if it is judged that the BPM value is not measured (the step S102: No), a warning statement or the like which indicates that the BPM candidate value cannot be measured is displayed (step S103), and the operational flow returns to the step S101 to continue the measurement of the BPM value. On the other hand, if it is judged that the BPM value is measured (the step S102: Yes), then the beat position and a beat head (i.e. the head portions of the beats) are detected by the operation of the signal level detection block 212 (step S104).

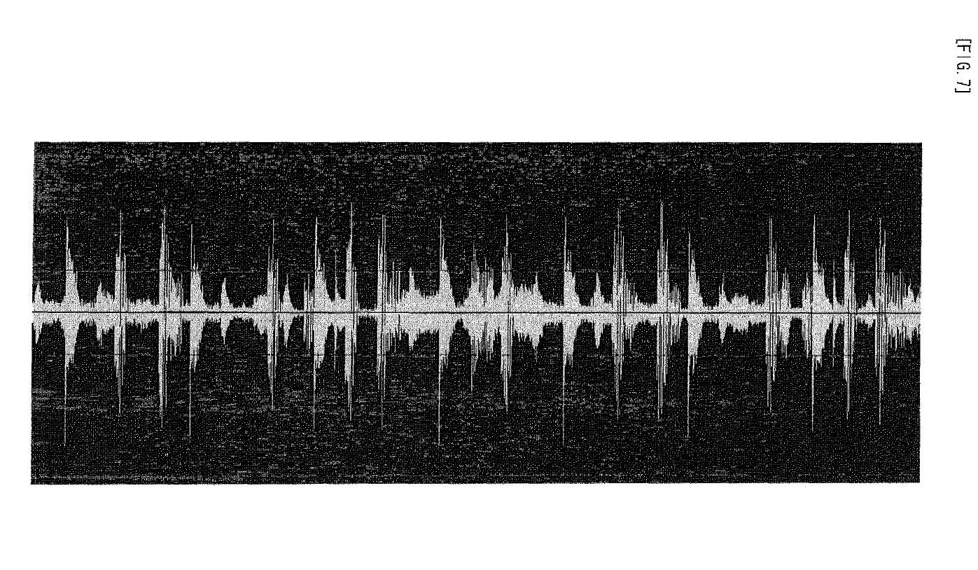

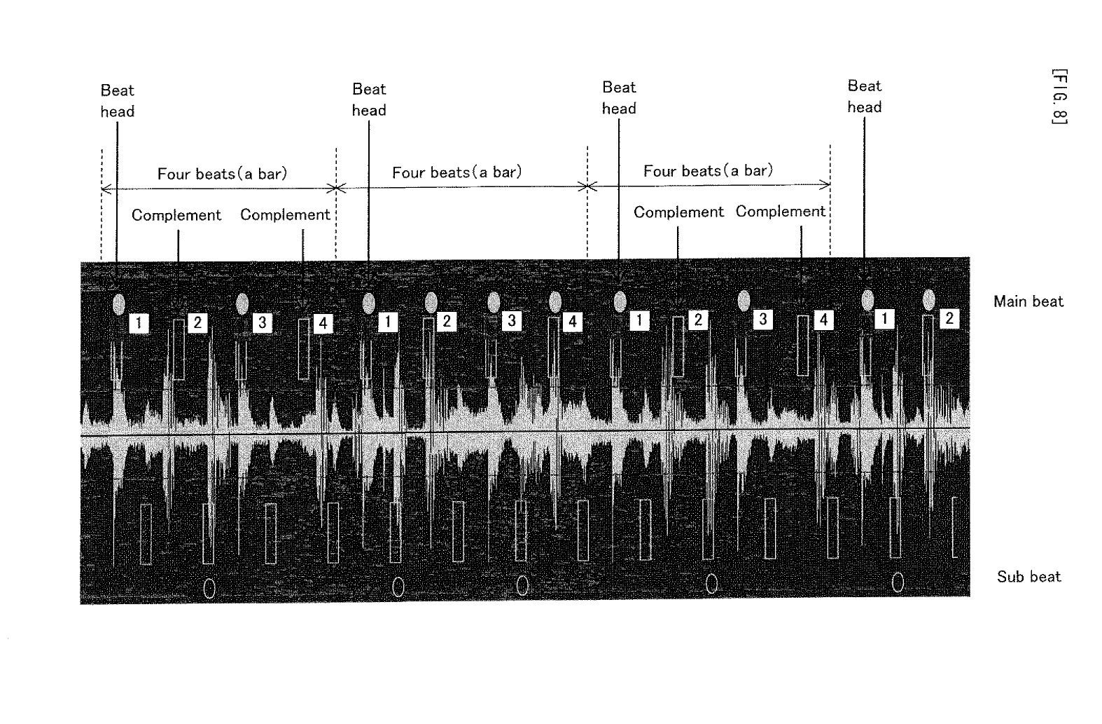

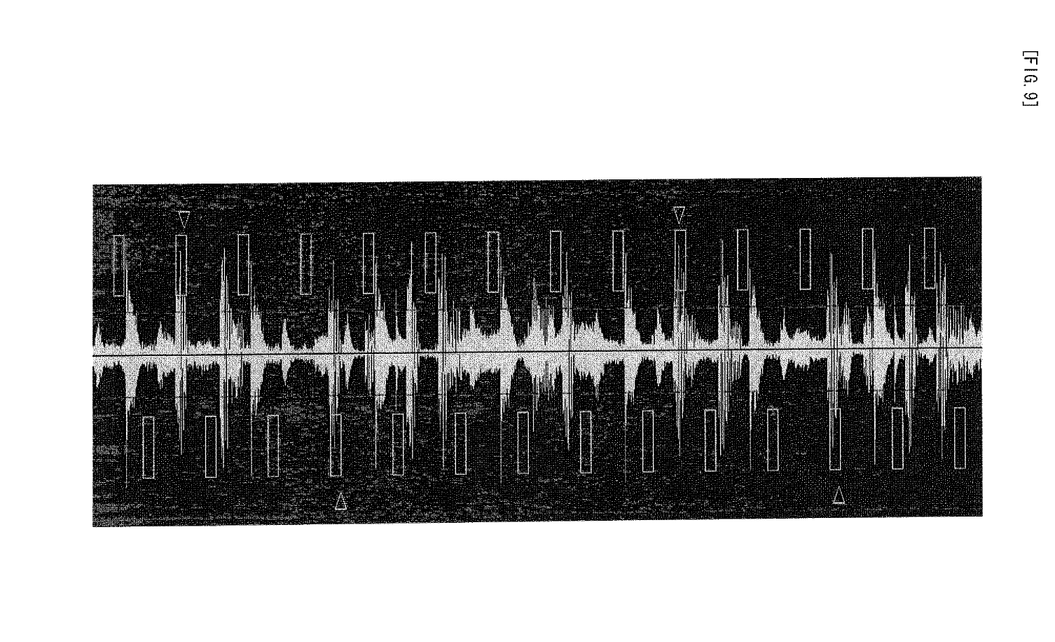

The detection of the beat position and the beat head will be explained in more detail with reference to FIG. 7 to FIG. 9. FIG. 7 is a waveform chart conceptually showing one procedure of the detection of the beat position and the beat head. FIG. 8 is a waveform chart conceptually showing another procedure of the detection of the beat position and the beat head. FIG. 9 is a waveform chart conceptually showing another procedure of the detection of the beat position and the beat head. Incidentally, the detection of the beat position and the like explained here is performed in the measurement of the BPM value described above. Therefore, substantially, the step S101 in FIG. 5 and the step S104 may be performed in parallel. In that case, the BPM measurement block 211 and the signal level detection block 212 may not be clearly distinguished.

It is assumed that a reproduction signal shown in FIG. 7 is obtained by reproducing the content data. In this case, firstly, the BPM value is back-calculated, to thereby calculate the beat interval. After that, with setting the strong beat (in other words, the beat with a relatively high signal level) as a start point, it is judged whether or not there is a rising portion where the signal level starts to rise (i.e. a rising portion where the signal level is about to start increasing) at a distance of n/2 (n is an integer of 1 or more) of the beat interval before or after the start point. Here it is preferable to judge whether or not there is a rising portion where the signal level starts to rise at a distance of n/2 of the beat interval before or after the start point, with setting the strongest beat of the relatively strong beats included in the reproduction signal as the start point. As a result of the judgment, the rising portion where the signal level starts to rise is recognized to be the beat position.

Specifically, as shown in FIG. 8, out of the positions (the portion surrounded by square reference numbers) n/2 of the beat interval away from the strong beat as the start point, the positions expressed by white-outline circles or white circles which correspond to the rising portion where the signal level starts to rise are recognized to be the beat position. Here, moreover, it is necessary to judge whether the positions, which are expressed by the white circles and which correspond to the rising portion surrounded by the square reference-marks on the upper side in FIG. 8 arranged at the beat intervals, correspond to the actual beat position. Or, it is necessary to judge whether the positions, which are expressed by the white-outline circles and which correspond to the portion surrounded by the square reference-marks on the lower side in FIG. 8 arranged at the beat intervals, correspond to the actual beat position. In the embodiment, the side (upper side or lower side) that includes more circles is judged to be the actual beat position. Specifically, in FIG. 8, the positions which are expressed by the white circles and which correspond to the portion surrounded by the square reference-marks on the upper side are considered to be the actual beat position (main beat). On the other hand, the positions which are expressed by the white-outline circles and which correspond to the portion surrounded by the square reference-marks on the lower side, which is judged not to be the main beat, is judged to be the sub beat (back beat) position.

Moreover, with setting the strongest beat as the start point, if it is judged whether or not there is a rising portion where the signal level starts to rise at a distance of n/2 of the beat interval before or after the start point, in some cases there is the relatively strong beat, though it is not the strongest, at a position out of the judgment target. Therefore, in the embodiment, as shown in FIG. 9, with setting the relatively strong beat as the start point, it is judged whether or not there is a rising portion where the signal level starts to rise at a distance of n/2 of the beat interval before or after the relatively strong beat, even at the position out of the judgment target. As a result of the judgment, if the number of the rising portions where the signal level starts to rise located at a distance of n/2 of the beat interval before or after the strongest beat is more than the number of the portions where the signal level starts to rise located at a distance of n/2 of the beat interval before or after the relatively strong beat which is out of the judgment target, the portion where the latter starts to rise is recognized as the actual beat position. In FIG. 9, since four points which are expressed by white-outline triangles in FIG. 9 are recognized as the portion where the signal level stars to rise. Thus, in this case, the positions which are expressed by the white circles shown in FIG. 8 are recognized as the actual beat position.

After that, in view of the beat interval, in some cases the portion that is recognized as the main beat is judged to be lacking. In this case, as shown in FIG. 8, the beat is complemented as if there were a main beat in the middle of the main beats.

After that, as shown in FIG. 8, the beat position is divided every four beats, i.e. every one bar, and numbers of “1”, “2”, “3”, and “4” are assigned to the beats in each division (i.e. in each bar) in order. Then, the first beat in each division is set to the beat head.

In FIG. 5 again, then it is judged whether or not there is a TAP operation (step S113) by the user (step S105). Specifically, for example, it is judged whether or not the user operates the mouse 302 or the like, displaces the pointer 50 on the TAP button 14 and performs the click operation, to thereby press the TAP button 14.

As a result of the judgment, if it is judged that there is no TAP operation (the step S105: No), the operational flow goes to a step S107.

On the other hand, if it is judged that there is a TAP operation (the step S105: Yes), the beat inputted by the TAP operation is set to the beat head (step S106). For example, if the TAP operation is performed in accordance with the timing of the beat to which the number of “3” is assigned in FIG. 8, the beat to which the “3” is assigned is set to the beat head, and the number of “1” which indicates the beat head is newly assigned. After that, in accordance with the newly set beat head, the beat is divided every four beats to thereby set a new bar.

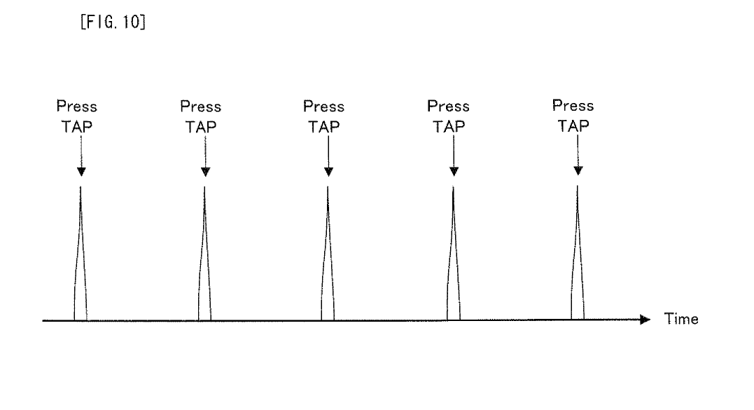

Now, the setting operation of the beat head by the TAP operation will be explained in more detail with reference to FIG. 10. FIG. 10 is a graph conceptually showing a waveform of a detection signal by the TAP operation.

As shown in FIG. 10, if the user presses the TAP button 14, the detection signal in which a pulse-shaped waveform appears in accordance with the pressing is detected, for example, on the signal level detection block 212. At his time, the user presses the TAP button 14 in accordance with the beat head of the reproduced content data (in other words, in accordance with the rhythm of the bar or the like of the content data). Therefore, the pulse-shaped waveform which appears in accordance with the pressing of the TAP button 14 substantially matches the beat head of the content data, and the interval of the pulse-shaped waveforms corresponds to the bar interval.

Moreover, the BPM value may be set by the TAP operation. Specifically, the numerical value obtained by multiplying the inverse number of the interval of the pulse-shaped waveforms by a predetermined coefficient may be set as the BPM value. However, in order to set the BPM value, the interval of the pulse-shaped waveforms is required, so that the user needs to press the TAP button 14 at least twice.

In this case, if the TAP button 14 is pressed in a row at intervals of less than about 300 milliseconds, the pressing of the TAP button 14 may be judged to be an operation for setting the BPM value. On the other hand, if the TAP button 14 is pressed in a row at intervals of about 300 milliseconds or more, or if the TAP button 14 is pressed only once, the pressing of the TAP button 14 may be judged to be the operation for setting the beat head. Alternatively, the TAP button 14 for setting the BPM value and the TAP button 14 for setting the beat head may be provided separately and independently; namely, there may be provided two TAP buttons 14 for performing different operations.

In FIG. 5 again, then the display timing of the beat guide 120 is generated by the operation of the guide timing generation block 213 (step S107). Here, the display timing of the beat guides 120 having uniform intervals along a time axis is generated on the basis of the BPM value measured in the step S101. At this time, the display timing is preferably generated such that the head of the beat guide 120 is set to the beat head detected in the step S104 or set in the step S106.

At this time, with regard to the display timing of the beat guide 120 generated on the basis of the BPM value, because the display timing interval is fixed on the basis of the BPM value, the display position of the beat guide 120 on the reproduction state display portion 12 and the actual beat position are sometimes shifted depending on the characteristic of the content data including the music song or the like. In other words, even if the beat guide 120 is displayed on the reproduction state display portion 12 on the basis of the timing generated in the step S106, the beat guide 120 may not indicate the beat position on the actual reproduction signal in some cases. Specifically, for example, the music song does not necessarily have the uniform BPM value in the entire reproduction time but generally changes every moment along with the reproduction, and the rhythm or the like of the music song also continuously changes. The change in the BPM value and the rhythm or the like along with the reproduction possibly makes the display position of the beat guide 120 and the actual beat position shift to each other, and there is a possibility that the beat guide 120 which is originally to indicate the beat position does not function correctly. Therefore, in the embodiment, the position of the display timing of the beat guide 120 is corrected as explained below.

Specifically, firstly, a section in which a shift amount between the display timing of the beat guide 120 generated in the step S107 and the actual beat position (specifically, the beat timing) detected in the step S104 or set in the step S106 is calculated is set by the operation of the timing comparison/analysis block 214 (step S108). For example, the section may be set to calculate the shift amount every bar or every several bars, or the section may be set to calculate the shift amount every several beats. Alternatively, the shift amount may be calculated in each section in which the BPM value changes, or the shift amount may be calculated in each section having a predetermined reproduction lime. The following operation is performed by a unit of section set in the step S108.

Then, the shift amount between the display timing of the beat guide 120 generated in the step S107 and the actual beat position detected in the step S104 or set in the step S106 is calculated in each section set in the step S108 by the operation of the timing comparison/analysis block 214 (step S109). In other words, the shift amount on the time axis between the display position of the beat guide 120 generated in the step S107 and the actual beat position detected in the step S104 or set in the step S106 is calculated in each section set in the step S108 by the operation of the timing comparison/analysis block 214.

After that, the offset amount which indicates the amount of shifting the display timing of the beat guide 120 is set on the basis of the shift amount calculated in the step S109 in each section set in the step S108 by the operation of the timing comparison/analysis block 214 (step S110).

Then, after the offset amount set in the step S110 is added to the display timing of the beat guide 120, the beat guide 120 is displayed on the reproduction state display portion 12 with the reproduction signal of the content data by the operation of the display block 215 (step S111). Incidentally, in addition to or instead of displaying the beat guide 120 overlapping the reproduction signal of the content data, after the offset amount set in the step S110 is added to the display timing of the beat guide 120, the indicator 15 may be blinked in accordance with the reproduction of the content data. That is, the indicator 15 may be blinked at the moment when the data portion of the content data is reproduced at the position where the beat guide 120 is displayed.

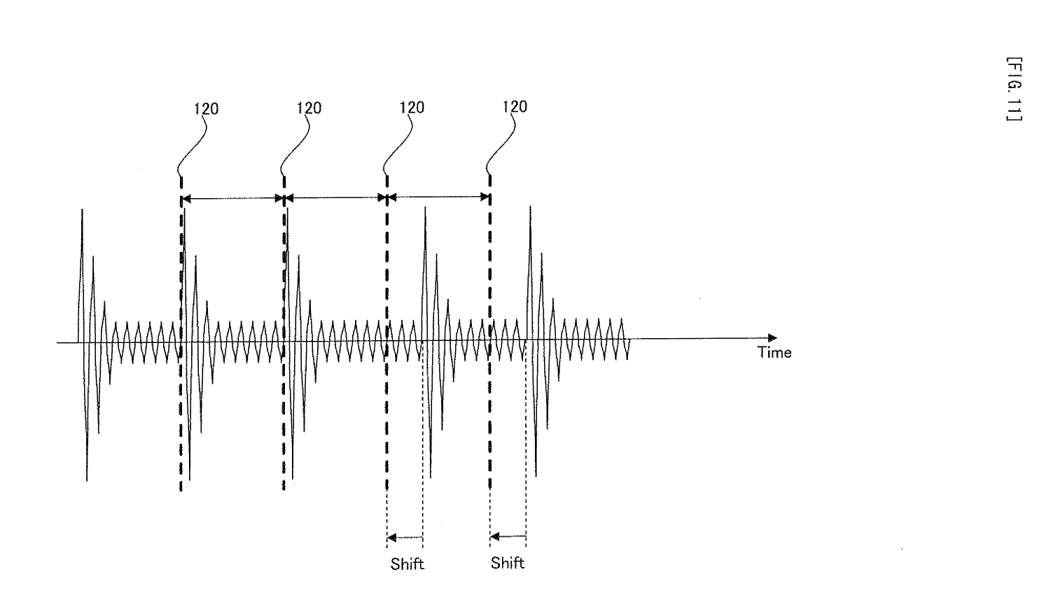

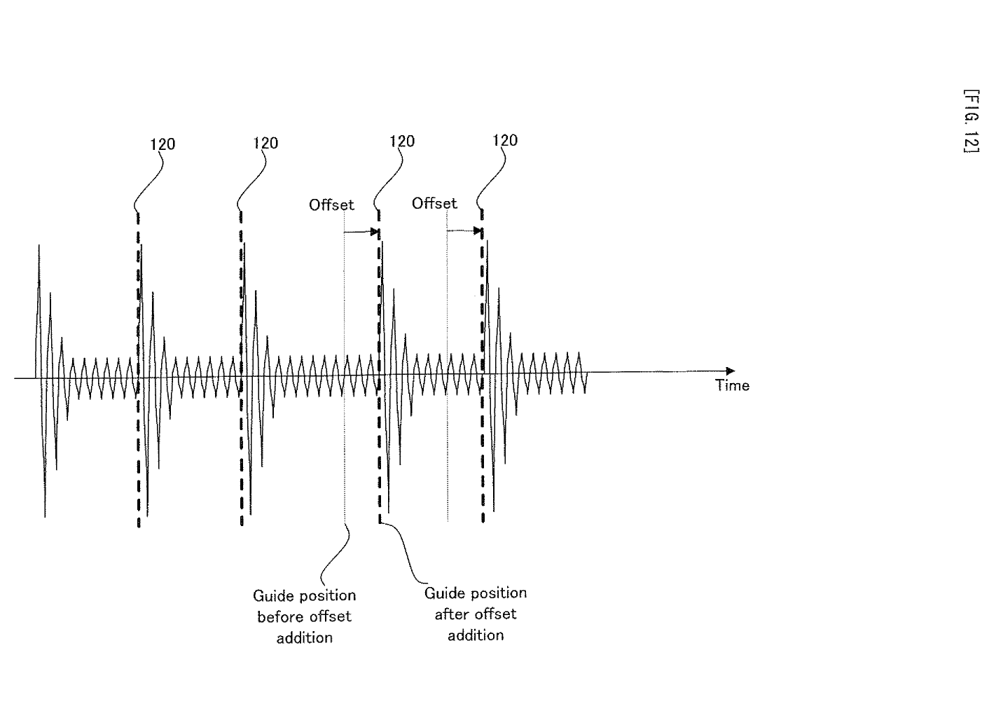

The operations from the step S108 to the step S112 will be explained in more detail with reference to FIG. 11 and FIG. 12. FIG. 11 is a waveform chart generally showing a relationship between the beat position and the position of the beat guide 120 before the offset amount is added. FIG. 12 is a waveform chart generally showing a relationship between the beat position and the position of the beat guide 120 after the offset amount is added.

FIG. 11 shows the aspect that the display timing of the beat guides 120 with the uniform intervals is generated on the basis of the measured BPM value and the beat guide 120 are displayed on the basis of the display timing. At this time, because of the change in the rhythm of the content data including the music song, the third and fourth beat guides 120 in FIG. 11 are displayed at positions shifted from the actual beat positions. In this case, it is assumed that the first and second beat guides 120 are in the section, which is set in the step S108 in FIG. 5 to calculate the shift amount, different from the sections of the third and fourth beat guides 120.

If the shift amount in the section including the third and fourth beat guides 120 corresponds to the shift amount between the third and fourth beat guides 120 and the beat positions, the third and fourth beat guides 120 after the offset amount is added are displayed to overlap the beat positions, as shown in FIG. 12, because the set offset amount corresponds to the shift amount.

Incidentally, the shift between the display position of the beat guide 120 and the beat peak position (i.e. the top portion of the beat) may be calculated as the shift amount. Or the shift between the position of the beat guide 120 and the beat rising position (i.e. the portion where the signal level starts to increase) may be calculated as the shift amount. However, considering that the user reproduces the different content data including different music songs in a row or with them overlapping without an uncomfortable feeling, with reference to the position of the beat guide 120, it is preferable to calculate the shift between the position of the beat guide 120 and the beat rising position as the shift amount. In this case, by adding the offset amount, the beat guide 120 is displayed at a position matching or close to the beat rising position.

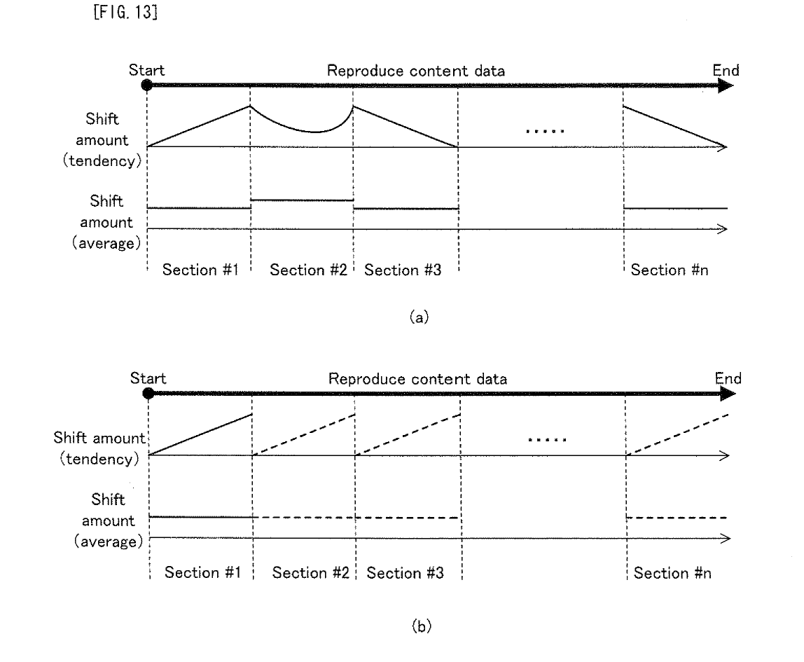

Moreover, the relationship among the setting of the section, the calculation of the shift amount in each section, and the offset amount based on the shift amount will be explained in more detail with reference to FIG. 13. FIG. 13 are graphs conceptually showing the shift amount in each section and aspects of setting the offset amount based on the shift amount.

As shown in the middle of FIG. 13(a), a tendency in the change of the shift amount in each section may be calculated, and the offset amount which changes in the same aspect as in the tendency in the change of the shift amount in each section may be added to the timing of the beat guide 120. In other words, the offset amount may be added to the display timing of the beat guide 120 in real time in accordance with the shift amount. Specifically, in a section #1, the shift amount changes to monotonically increase. Therefore, in the section #1, the offset amount which monotonically increases along with the elapse of the reproduction time of the content data shown in the upper part in FIG. 13(a) is added. On the other hand, in a section #2, the shift amount changes in a curved line. Therefore, in the section #2, the offset amount which changes in the same aspect as the curved line of the shift amount in the reproduction time of the content data is added. On the other hand, in a section #3, the shift amount changes to monotonically decrease. Therefore, in the section #3, the offset amount which monotonically decreases along with the elapse of the reproduction time of the content data is added.

Alternatively, as shown in the lower part of FIG. 13(a), the average of shift amount in each section may be calculated, and the offset amount which is substantially the same as the average of the shift amount is added to the timing of the beat guide in each section.

Alternatively, as shown in FIG. 13(b), a tendency in the change of the shift amount in a certain section or the average of the shift amount may be calculated, and the offset amount set on the basis of the shift amount in the certain section may be commonly added to the timing of the beat guide 120 in all the sections. Specifically, under the assumption that the tendency in the change of the shift amount calculated in the section #1 or the average of the shift amount is repeated even after the section #2, the offset amount added in the section #1 may be used after the section #2. This is efficient particularly for the content data including the music song in which the same rhythm is repeated in predetermined cycles.

In FIG. 5 again, then it is judged whether or not the reproduction of the content data is ended (step S112).

As a result of the judgment, if it is judged that the reproduction of the content data is not ended (the step S112: No), the operation from the step S101 to the step S111 and the step S113 are repeated. On the other hand, if it is judged that the reproduction of the content data is ended (the step S112; Yes), the reproduction of the content data is ended.

As explained above, in the embodiment, normally, with respect to the beat guide 120 overlapping and displayed on the reproduction signal of the content data with predetermined intervals corresponding to the BPM value, the timing of the beat guide 120 (i.e. the display timing of the beat guide 120) can be corrected on the basis of the positional shift between the beat guide 120 and the beat position. Thus, it is possible to present the beat guide 120 preferably corresponding to the beat position, to the user. Therefore, the user can preferably set the cue of the content data and a reproduction start point to the beat position, with reference to the beat guide 120 preferably corresponding to the beat position. As a result, it is possible to reproduce the content data in a more preferable aspect.

(3) Information Reproducing Apparatus

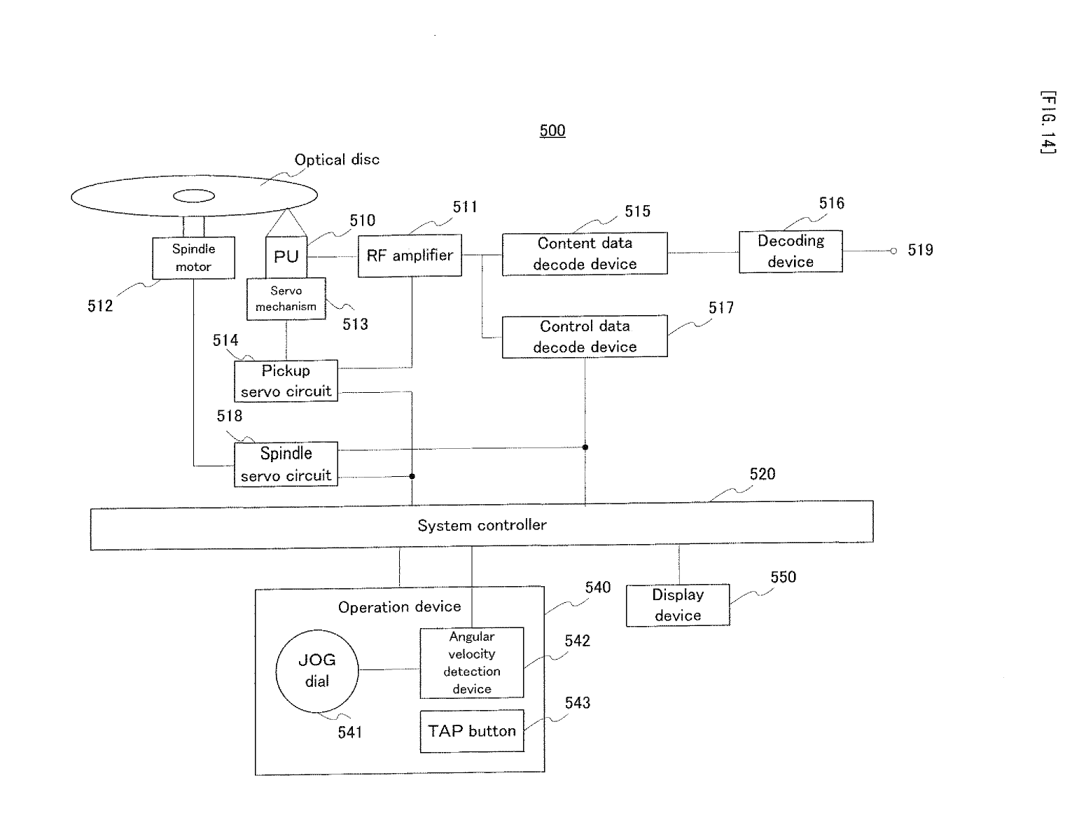

Next, an explanation will be given on an optical disc reproducing apparatus which realizes the optical disc reproduction system 1 in the embodiment described above as an exclusive hardware apparatus, with reference to FIG. 14. In other words, an explanation will be given on the optical disc reproducing apparatus as the exclusive hardware apparatus, which has the same function as that of the optical disc reproduction system 1 realized on the commercial computer 200. FIG. 14 is a block diagram conceptually showing the basic structure of an optical disc reproducing apparatus 500 in an embodiment.

As shown in FIG. 14, the optical disc reproducing apparatus 500 is provided with: an optical pickup (PU: Pick Up) 510; a RF (Radio Frequency) amplifier 511; a spindle motor 512; a servo mechanism 513; a pickup servo circuit 514; a content data decode device 515; a decoding device 516; a control data decode device 517; a spindle servo circuit 518; an external output terminal 519; a system controller 520; an operation device 540; and a display device 550.

The optical pickup 510 is intended to read the content data and control data from the optical disc, and it is provided with a semiconductor laser apparatus, various lenses, an actuator and the like. More specifically, the optical pickup 510 irradiates laser light LB to the optical disc with a predetermined power. Moreover, the optical pickup 510 is provided with a PD (Photo Detector) sensor for receiving reflected light of the laser light LB from the optical disc, and it outputs the received reflected light as a reading signal to the RF amplifier 511.

The optical pickup 510 can be displaced in a radial direction or the like of the optical disc in accordance with a tracking error signal, by using a not-illustrated actuator, slider, or the like, which is driven by the control of the servo mechanism 513. In addition, the optical pickup 510 can be focus-controlled by changing the focal point of the laser light LB in accordance with a focus error signal by the control of the servo mechanism 513.

The RF amplifier 511 generates a RF signal on the basis of the reading signal outputted from the optical pickup 510 and outputs the generated RF signal to each of the content data decode device 515 and the control data decode device 517. Moreover, the RF amplifier 511 generates an error signal, such as the focus error signal for controlling the focus when the optical pickup 510 irradiates the laser light LB to the optical disc and the tracking error signal for controlling the tracking when the optical pickup 510 irradiates the laser light LB to the optical disc, on the basis of the reading signal outputted from the optical pickup 510. The generated error signal is outputted to the pickup servo circuit 514.

The spindle motor 512 is adapted to rotate the optical disc at a predetermined speed under spindle servo by the spindle servo circuit 518.

The servo mechanism 513 displaces the optical pickup 510 in the radial direction of the optical disc on the basis of a tracking servo control signal outputted from the pickup servo circuit 514. Moreover, the servo mechanism 513 displaces an objective lens included in the optical pickup 510 along the optical axis of the laser light LB on the basis of a focus servo control signal outputted from the pickup servo circuit 514.

The pickup servo circuit 514 generates the focus servo control signal and the tracking servo control signal for controlling the servo mechanism 513, on the basis of the error signal outputted from the RF amplifier 511. The generated focus servo control signal and tracking servo control signal are outputted to the servo mechanism 513. In other words, in order to prevent a focus error and a tracking error from occurring, the servo mechanism 513 is feedback-controlled on the basis of the error signal outputted from the RF amplifier 511.

The content data decode device 515 decodes the RF signal outputted from the RF amplifier 511 to thereby generate a stream signal including a video stream and an audio stream. The generated stream signal is outputted to the decoding device 516.

The decoding device 516 decodes the stream signal outputted from the content data decode device 515 to thereby generate a reproduction signal. The generated reproduction signal is outputted to external output equipment, such as a display and a speaker, through the external output terminal 519, and it is reproduced as video images and audio according to the content data recorded on the optical disc.

Incidentally, after a predetermined modulation process is performed on the reproduction signal outputted from the decoding device 516, the modulated reproduction signal may be outputted to the external output equipment. More specifically, modulation by a sawtooth wave may be performed on the reproduction signal, or modulation by a rectangular wave may be performed on the reproduction signal. For example, modulation which causes the Doppler effect may be performed. For example, modulation by a special waveform which imitates the sound of a jet plane may be performed. For example, modulation by a special waveform which imitates the bark of a gun may be performed. For example, modulation by various special waveforms set in advance by the user or the like may be performed. These modulation are preferably performed by the user operating not-illustrated operation keys on the operation device 540.

The control data decode device 517 decodes the RF signal outputted from the RF amplifier 511 to thereby generate the control data for controlling the reproduction of the content data. The control data includes TOC data or the like recorded in a lead-in area of the optical disc, synchronization data recorded and included in the stream signal, and sub-code data or the like including time-elapse information when the content data is reproduced, as one specific example. The generated control data is outputted to the system controller 520 and is used to control the reproduction of the content data.

The spindle servo circuit 518 detects an error in the synchronization data with respect to the rotational speed of the spindle motor 512 instructed from the system controller 520, and feedback-controls the rotation of the spindle motor 512 in order to prevent the error from occurring.

The system controller 520 is provided with a micro processor (MPU), and it performs central control on the entire operation of the optical disc reproducing apparatus 500 by executing a system program set in advance.

Moreover, the system controller 520 is connected with the operation device 540 and the display device 550. Instruction data from various operation keys disposed on the operation device 540 is outputted to the system controller 520, and the system controller 520 controls the reproduction of the control data in accordance with the instruction data. Moreover, the system controller 520 controls the display operation of the display device 550.

The operation device 540 is provided with: a jog dial 541; an angular velocity detection device 542; and a TAP button 543.

The jog dial 541 is a disc-shaped operation key which can be operated directly by the user and which can be physically rotated in the both directions, The jog dial 541 has the same function as that of the jog dial 17 of the player menu 11 described above.

The angular velocity detection device 542 detects the rotational direction and the rotational speed (angular velocity) of the jog dial 541. More specifically, the angular velocity detection device 542 is provided with a rotary encoder circuit and optically detects the rotational direction and the rotational speed of the jog dial 541. The detected rotational direction and rotational speed of the jog dial 541 are outputted to the system controller 520. By this, the system controller 520 recognizes the amount of operating the Jog dial 541 operated by the user or the like to perform an effect process according to the operation amount.

The TAP button 543 can be operated directly by the user and can be pressed. The TAP button 543 has the same function as that of the TAP button 14 of the player menu 11 described above.

The display device 550 displays various information which accompany the reproduction of the content data. The display device 550 is provided with a display panel, such as a liquid crystal display and a fluorescent tube, and displays the various information under the control of the system controller 520. Specifically, the display device 550 displays the BPM value, the beat guide 120 or the like.

Even in the optical disc reproducing apparatus 500 as the exclusive hardware apparatus, the same benefits as those in the aforementioned optical disc reproduction system 1 can be received by performing the aforementioned operations (specifically, the operations explained in FIG. 5 to FIG. 11), under the control of the system controller 520/

Incidentally, out of the constituent elements of the optical disc reproducing apparatus 500, mainly the optical pickup 510, the RF amplifier 511, the spindle motor 512, the servo mechanism 513, the pickup servo circuit 514, and the spindle servo circuit 518 are substantially the same as those in the structure in the optical disc drive 500 in the aforementioned optical disc reproduction system 1. Moreover, out of the constituent elements of the optical disc reproducing apparatus 500, mainly the content data decode device 515, the decoding device 516, the control data decode device 517, and the system controller 520 are realized as the function block on the computer 200 (specifically, the CPU 201 in the computer 200) in the aforementioned optical disc reproduction system 1. Therefore, it can be said that the optical disc reproducing apparatus 500 and the optical disc reproduction system 1 are basically the same apparatus.

In the aforementioned embodiments, the optical disc reproduction system and apparatus are explained as one example of the information reproducing apparatus. The present invention, however, is not limited to the optical disc and the reproduction system and apparatus thereof. The present invention can be also applied to other various information recording media which support high-density recording and high transmission rate and the player thereof.

The present invention is not limited to the aforementioned embodiments, but various changes may be made without departing from the essence or spirit of the invention which can be read from the claims and the entire specification. An information reproducing apparatus and method and a computer program, which involve such changes, are also intended to be within the technical scope of the present invention.

### INDUSTRIAL APPLICABILITY

The computer program and the information reproducing apparatus and method according to the present invention can be applied to an information reproducing apparatus, such as a DVD player. Moreover, they can be also applied to an information reproducing apparatus or the like which can be mounted on or which can be connected to various computer equipment for commercial use or for business use.

1. A computer program product in a computer-readable medium for making a computer perform:
a measuring process of measuring a beat rate, which is the number of beats of content per unit time;
a first detecting process of detecting a beat position;
a generating process of generating a beat guide which is to be displayed in accordance with the beat position and which has a substantially uniform interval in accordance with the beat rate along a time axis, on the basis of the beat rate and the beat position;
a second detecting process of detecting a positional shift between the beat guide and the beat position;
an offset process of adding an offset to a position of the beat guide on the basis of the positional shift; and
a displaying process of displaying the beat guide to which the offset is added.

2. The computer program product according to claim 1, wherein
said second detecting process detects the positional shift between the beat guide and the beat position in an at least partial reproduction section of the content, and
said offset process adds the offset to the position of the beat guide in the at least partial reproduction section, on the basis of the positional shift in the at least partial reproduction section.

3. The computer program product according to claim 2, wherein said offset process adds the offset to the position of the beat guide in a reproduction section other than the at least partial reproduction section, on the basis of the positional shift in the at least partial reproduction section.

4. The computer program product according to claim 2, wherein the at least partial reproduction section is at least one reproduction section in the case where the content is divided into a plurality of reproduction sections along a time axis on the basis of the beat rate.

5. The computer program product according to claim 2, wherein the at least partial reproduction section is at least one reproduction section in the case where the content is divided into a plurality of reproduction sections along a time axis on the basis of a reproduction time of the content.

6. The computer program product according to claim 1, wherein
said second detecting process detects the positional shift between the beat guide and a rising portion of the beat position, and
said offset process adds the offset to the position of the beat guide such that the beat guide corresponds to the rising portion of the beat position on the basis of the positional shift.

7. The computer program product according to claim 1, wherein
said second detecting process detects the positional shift between the beat guide and a peak portion of the beat position, and
said offset process adds the offset to the position of the beat guide such that the beat guide corresponds to the peak portion of the beat position on the basis of the positional shift.

8. The computer program product according to claim 1, wherein said second detecting process detects an average value of positional shifts between a plurality of beat guides and a plurality of beat positions corresponding to the respective plurality of beat guides, as the positional shift.

9. The computer program product according to claim 1, wherein said second detecting process detects a tendency in a change of the positional shift between the beat guide and the beat position, as the positional shift.

10. The computer program product according to claim 1, wherein the offset is fixed.

11. The computer program product according to claim 1, wherein the offset is variable.

12. The computer program product according to claim 1, wherein said displaying process displays the beat guide with a waveform of a reproduction signal of the content.

13. The computer program product according to claim 1, wherein the content includes music content.

14. The computer program product according to claim 1, wherein said displaying process displays the beat guide generated in said generating process before displaying the beat guide to which the offset is added.

15. An information reproducing apparatus comprising:
a measuring device for measuring a beat rate, which is the number of beats of content per unit time;
a first detecting device for detecting a beat position;
a generating device for generating a beat guide which is to be displayed in accordance with the beat position and which has a substantially uniform interval in accordance with the beat rate along a time axis, on the basis of the beat rate and the beat position;
a second detecting device for detecting a positional shift between the beat guide and the beat position;
an offset device for adding an offset to a position of the beat guide on the basis of the positional shift; and
a displaying device for displaying the beat guide to which the offset is added.

16. An information reproducing method comprising:
a measuring process of measuring a beat rate, which is the number of beats of content per unit time;
a first detecting process of detecting a beat position;
a generating process of generating a beat guide which is to be displayed in accordance with the beat position and which has a substantially uniform interval in accordance with the beat rate along a time axis, on the basis of the beat rate and the beat position;
a second detecting process of detecting a positional shift between the beat guide and the beat position;
an offset process of adding an offset to a position of the beat guide on the basis of the positional shift; and
a displaying process of displaying the beat guide to which the offset is added.
